(19) United States
(12) Patent Application Publication
(10) Pub. No.: US 2024/0384847 A1
(43) Pub. Date: Nov. 21, 2024

(54) CANDLE LAMP

(71) Applicants: DONGGUAN XUANXIN ELECTRONIC CO., LTD., Dongguan (CN); BESTWORLD CORPORATION LIMITED, Hong Kong (CN)

(72) Inventor: Zhengyong LIU, Dongguan (CN)

(73) Assignees: DONGGUAN XUANXIN ELECTRONIC CO., LTD., Dongguan (CN); BESTWORLD CORPORATION LIMITED, Hong Kong (CN)

(21) Appl. No.: 18/217,549

(22) Filed: Jul. 1, 2023

(30) Foreign Application Priority Data
May 19, 2023 (CN) 202310575575.5

(51) Int. Cl. F21S 10/04

(52) U.S. Cl. CPC F21S 10/046

(57) ABSTRACT

A candle lamp is disclosed, which relates to the technical field of lighting devices. The candle lamp includes a shell, a swinging part and a magnetic driving assembly; the shell is provided with an accommodating cavity and a through port, and the through port is communicated with the accommodating cavity; the swinging part includes a magnet, a swinging assembly and a lamp body; the swinging assembly is movably arranged in the accommodating cavity, one end of the swinging assembly is movably arranged at the through port and connected with the lamp body, the lamp body is located outside the accommodating cavity, and the magnet is connected with the swinging assembly; and the magnetic driving assembly is arranged in the accommodating cavity and located on one side of the magnet, and the magnetic driving assembly is capable of driving the magnet to move by a magnetic force.

### CROSS-REFERENCE TO RELATED APPLICATION

This application is based on and claims the benefit of priority from Chinese Patent Application No. 2023105755755, filed on 19 May 2023, the entirety of which is incorporated by reference herein.

### TECHNICAL FIELD

The disclosure relates to the technical field of lighting devices, and particularly to a candle lamp.

### BACKGROUND

In modern social life, electric lamps have basically met people's lighting requirement. However, with the increase of people's living standard, people often choose to use candles to create a romantic atmosphere, or use candles as decorations to meet people's decorative requirement. The candles need to undergo combustion reaction in use, which will generate a high flame temperature. However, because the candles are typically in a shape of a slender cylinder, they are prone to be pushed down due to human factors or other unexpected factors to cause a fire disaster, thus having low safety.

### SUMMARY

The disclosure aims to solve at least one of the technical problems in the existing technology. Therefore, the disclosure provides a candle lamp, which can replace a candle to meet people's decorative requirement, and has high safety.

A candle lamp according to an embodiment of the disclosure comprises: a shell provided with an accommodating cavity and a through port, wherein the through port is communicated with the accommodating cavity; a swinging part comprising a magnet, a swinging assembly and a lamp body, wherein the swinging assembly is movably arranged in the accommodating cavity, one end of the swinging assembly is movably arranged at the through port and connected with the lamp body, the lamp body is located outside the accommodating cavity, and the magnet is connected with the swinging assembly; and a magnetic driving assembly arranged in the accommodating cavity and located on one side of the magnet, wherein the magnetic driving assembly is capable of driving the magnet to move by a magnetic force.

The candle lamp according to the embodiment of the disclosure has at least the following beneficial effects. In the embodiment of the disclosure, the lamp body can emit light, the lamp body is located outside the accommodating cavity, and the lamp body and the magnet are both connected with the swinging assembly. Because the swinging assembly is movably arranged in the accommodating cavity, the swinging assembly is movable in the accommodating cavity, and the magnetic driving assembly drives the magnet to move by the magnetic force, so as to drive the swinging assembly to move, so that the lamp body can be driven to move. Moreover, one end of the swinging assembly connected with the lamp body is movably arranged at the through port, so that the one end of the swinging assembly located at the through port is movable in the through port, and then the magnetic driving assembly is movable by driving the magnet, so as to drive the lamp body to move up and down and swing back and forth, and therefore the lamp body can simulate jumping of a flame on a candle. During swinging of the swinging assembly, the swinging assembly can abut against an inner wall of the through port, so that the through port of the shell can limit the swinging assembly. The lamp body can imitate the flame on the candle when the candle lamp is used, so that the candle lamp can replace the candle to meet people's decorative requirement, and the candle lamp has high safety.

According to some embodiments of the disclosure, the swinging assembly comprises a connecting member and a swinging member, the connecting member is connected with the swinging member and located at the through port, the lamp body is connected with the connecting member, the magnet is arranged on one side of the swinging member far away from the connecting member, and the magnetic driving assembly is located on one side of the magnet far away from the connecting member.

According to some embodiments of the disclosure, the candle lamp further comprises a limiting assembly, wherein the limiting assembly is arranged in the accommodating cavity, and the limiting assembly is located on one side of the through port and is capable of abutting against the swinging assembly.

According to some embodiments of the disclosure, the swinging member is provided with a first opening, and one end of the limiting assembly is movably arranged in the first opening.

According to some embodiments of the disclosure, one side of the swinging member close to the through port is provided with a second opening, the connecting member is arranged in the second opening, and the second opening and the first opening are communicated with each other.

According to some embodiments of the disclosure, the swinging member comprises a first connecting structure, a second connecting structure and a connecting rod, the connecting rod is arc-shaped, two connecting rods are provided and arranged symmetrically, two ends of the connecting rod are respectively connected with the first connecting structure and the second connecting structure, the first connecting structure is connected with the connecting member, and the magnet is arranged on the second connecting structure.

According to some embodiments of the disclosure, the limiting assembly comprises a mounting member and a limiting rod, the mounting member is arranged on an inner wall of the accommodating cavity, the limiting rod comprises a first rod member and a second rod member, the first rod member is connected with the mounting member, one end of the second rod member is connected with the first rod member, and the other end of the second rod member is movably arranged in the first opening.

According to some embodiments of the disclosure, one end of the first rod member close to the second rod member is provided with a first through hole, the second rod member is provided with a second through groove, and the first through hole is communicated with the second through groove.

According to some embodiments of the disclosure, the inner wall of the accommodating cavity is provided with a second through hole, a first through groove is defined between the first rod member and the mounting member, and two ends of the first through groove are respectively communicated with the first through hole and the second through hole.

According to some embodiments of the disclosure, the shell comprises a first shell body and a second shell body, the first shell body is detachably connected with the second shell body, the through port and the accommodating cavity are formed between the first shell body and the second shell body, and the mounting member is arranged on the first shell body.

Additional aspects and advantages of the disclosure will be given in part in the following description, which will become apparent from the following description or be understood through practice of the disclosure.

### BRIEF DESCRIPTION OF THE DRAWINGS

The above or additional aspects and advantages of the disclosure will become apparent and easy to understand from the descriptions of embodiments with reference to the following drawings, wherein:

FIG. 1 is a schematic structural diagram of a candle lamp of the disclosure;

FIG. 2 is a sectional view of the candle lamp in FIG. 1;

FIG. 3 is a schematic structural diagram of a swinging member of the candle lamp of the disclosure;

FIG. 4 is a schematic structural diagram of a limiting rod of the candle lamp of the disclosure:

FIG. 5 is a schematic structural diagram of a shell and a mounting member of the candle lamp of the disclosure; and

FIG. 6 is a sectional view of the candle lamp of the disclosure from another perspective.

### REFERENCE NUMERALS

100 refers to shell; 101 refers to first shell body; 102 refers to second shell body; 110 refers to accommodating cavity; 111 refers to second through hole; 120 refers to through port; 200 refers to swinging part; 210 refers to magnet; 220 refers to swinging assembly; 221 refers to connecting member, 222 refers to swinging member; 223 refers to first opening; 224 refers to second opening; 225 refers to first connecting structure; 226 refers to second connecting structure; 227 refers to connecting rod; 230 refers to lamp body; 300 refers to limiting assembly; 310 refers to mounting member; 311 refers to mounting groove; 312 refers to second bump; 320 refers to limiting rod; 321 refers to first rod member; 322 refers to second rod member; 323 refers to first through groove; 324 refers to second through groove; 325 refers to first through hole; 326 refers to limiting block; 327 refers to first bump; 400 refers to magnetic driving assembly; 410 refers to supporting frame; and 420 refers to induction coil.

### DETAILED DESCRIPTION

Embodiments of the disclosure are described below in detail, and examples of the embodiments are shown in the drawings, wherein the same or similar reference numerals denote the same or similar elements or elements having the same or similar functions. The embodiments described hereinafter with reference to the drawings are exemplary, are only intended to explain the disclosure, and cannot be understood as limiting the disclosure.

In the description of the disclosure, it should be understood that the orientation or position relation related to the orientation description, such as the orientation or position relation indicated by “upper”, “lower”, “left”, “right”, “front”, “rear”, and the like, is based on the orientation or position relation shown in the drawings, which is only used for the convenience of description of the disclosure and simplification of description instead of indicating or implying that the indicated device or element must have a specific orientation, and be constructed and operated in a specific orientation, and thus should not be understood as a limitation to the disclosure.

In the description of the disclosure, if there are descriptions of first and second, it is only for the purpose of distinguishing between technical features, and shall not be understood as indicating or implying relative importance or implying the number of indicated technical features or implying the order of indicated technical features.

In the description of the disclosure, unless otherwise explicitly defined, the terms “setting”, “mounting” and “connecting” should be understood in a broad sense, and those of ordinary skills in the art can reasonably determine the specific meanings of the above terms in the disclosure in combination with the specific contents of the technical solution.

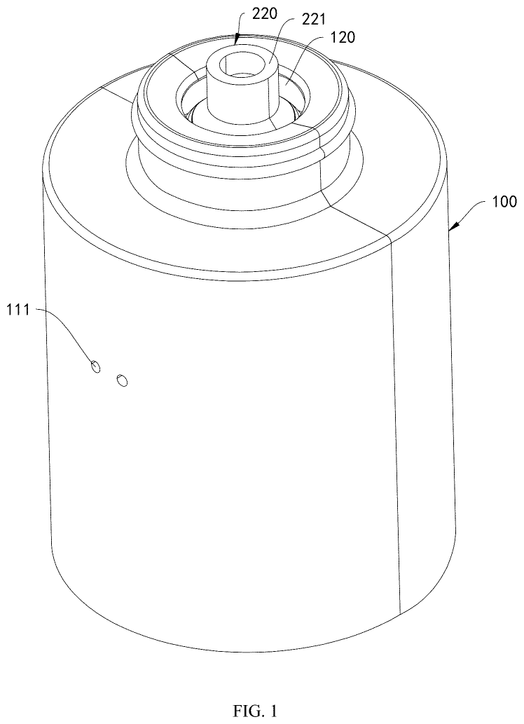

A candle lamp according to an embodiment of the disclosure is described hereinafter with reference to FIG. 1 to FIG. 6.

The candle lamp according to the embodiment of the disclosure comprises a shell 100, a swinging part 200 and a magnetic driving assembly 400. The shell 100 is provided with an accommodating cavity 110 and a through port 120, and the through port 120 is communicated with the accommodating cavity 110. The swinging part 200 comprises a magnet 210, a swinging assembly 220 and a lamp body 230. The swinging assembly 220 is movably arranged in the accommodating cavity 110, one end of the swinging assembly 220 is movably arranged at the through port 120 and connected with the lamp body 230, the lamp body 230 is located outside the accommodating cavity 110, and the magnet 210 is connected with the swinging assembly 220. The magnetic driving assembly 400 is arranged in the accommodating cavity 110 and located on one side of the magnet 210, and the magnetic driving assembly 400 can drive the magnet 210 to move by a magnetic force.

In the embodiment of the disclosure, the lamp body 230 can emit light, the lamp body 230 is located outside the accommodating cavity 110, and the lamp body 230 and the magnet 210 are both connected with the swinging assembly 220. Because the swinging assembly 220 is movably arranged in the accommodating cavity 110, the swinging assembly 220 is movable in the accommodating cavity 110, and the magnetic driving assembly 400 drives the magnet 210 to move by the magnetic force, so as to drive the swinging assembly 220 to move, so that the lamp body 230 can be driven to move. Moreover, one end of the swinging assembly 220 connected with the lamp body 230 is movably arranged at the through port 120, so that the one end of the swinging assembly 220 located at the through port 120 is movable in the through port 120, and then the magnetic driving assembly 400 is movable by driving the magnet 210, so as to drive the lamp body 230 to move up and down and swing back and forth, and therefore the lamp body 230 can simulate jumping of a flame on a candle. During swinging of the swinging assembly 220, the swinging assembly 220 can abut against an inner wall of the through port 120, so that the through port 120 of the shell 100 can limit the swinging assembly 220. The lamp body 230 can imitate the flame on the candle when the candle lamp is used, so that the candle lamp can replace the candle to meet people's decorative requirement, and the candle lamp has high safety.

Specifically, the lamp body 230 may be an incandescent lamp, a LED lamp or other light-emitting elements. The shell 100 may be provided with an observation window, and the observation window is set to be transparent, so that an operator can conveniently observe the situation in the accommodating cavity 110 from the outside, and then the internal situation of the shell 100 can be monitored in real time.

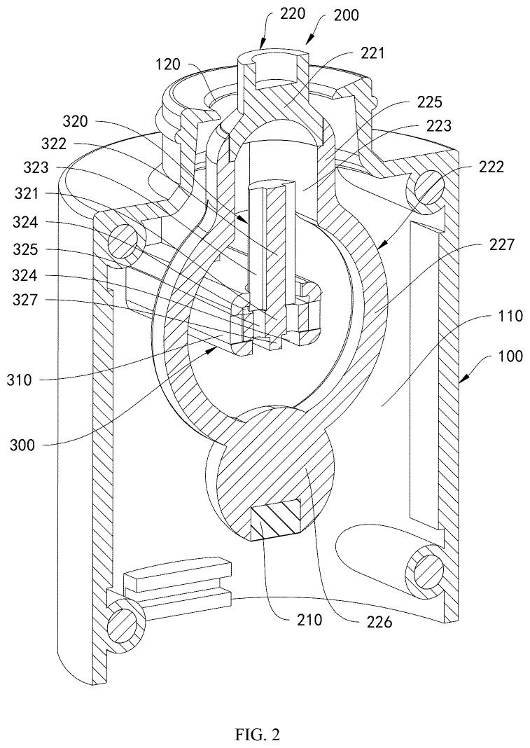

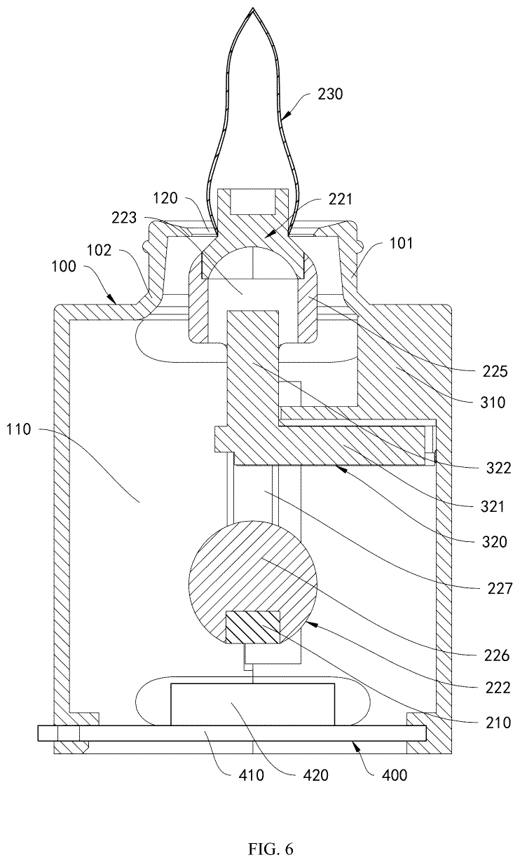

With reference to FIG. 1, FIG. 2 and FIG. 6, it is understandable that the swinging assembly 220 comprises a connecting member 221 and a swinging member 222, the connecting member 221 is connected with the swinging member 222 and located at the through port 120, the lamp body 230 is connected with the connecting member 221, the magnet 210 is arranged on one side of the swinging member 222 far away from the connecting member 221, and the magnetic driving assembly 400 is located on one side of the magnet 210 far away from the connecting member 221.

The connecting member 221 is used for connecting the lamp body 230 and the swinging member 222, the connecting member 221 is arranged at the through port 120, and during swinging of the swinging member 222, the connecting member 221 can abut against the inner wall of the through port 120, so that damage caused by friction between the through port 120, and the lamp body 230 and the swinging member 222 can be reduced.

With reference to FIG. 6, by arranging the magnet 210 on one side of the swinging member 222 far away from the connecting member 221 and arranging the magnetic driving assembly 400 on one side of the magnet 210 far away from the connecting member 221, difficulty in controlling the magnet 210 to move by the magnetic driving assembly 400 can be reduced. Specifically, the magnetic driving assembly 400 can drive the magnet 210 to move in a direction close to and far away from the through port 120, so as to drive the lamp body 230 to move up and down relative to the through port 120. Moreover, the connecting member 221 is arranged at the through port 120, and the magnetic driving assembly 400 can drive the magnet 210 to move left and right and back and forth, so that the swinging member 222 can be toppled over, and the connecting member 221 abuts against the inner wall of the through port 120, so as to limit the swinging member 222, and then limit the lamp body 230, so that the lamp body 230 can swing like the flame of the candle.

Specifically, the magnetic driving assembly 400 comprises an electric connection structure, a supporting frame and an induction coil, the supporting frame is arranged on the inner wall of the shell 100, the induction coil is arranged on the supporting frame and electrically connected with the electric connection structure, and the electric connection structure can transmit a current to the induction coil, so that the induction coil has the magnetic force.

With reference to FIG. 1 and FIG. 2, it is understandable that, the candle lamp further comprises a limiting assembly 300, wherein the limiting assembly 300 is arranged in the accommodating cavity 110, and the limiting assembly 300 is located on one side of the through port 120 and abuts against the swinging assembly 220.

By arranging the limiting assembly 300, the swinging assembly 220 can be limited, so as to limit a swinging degree of the swinging assembly 220, and avoid the connecting member 221 from falling out of the through port 120, so that operating stability of the candle lamp can be ensured.

Specifically, the limiting assembly 300 abuts against one side of the swinging member 222 far away from the connecting member 221. After the magnetic driving assembly pushes the magnet 210 to move in a direction close to the through port 120, the limiting assembly 300 and the swinging assembly 220 are separated from each other. After the magnetic driving assembly stops working, the limiting assembly 300 can support the swinging assembly 220, limiting the swinging assembly 220 and the lamp body 230, and avoiding the magnet 210 from colliding with the magnetic driving assembly 400 or other structures.

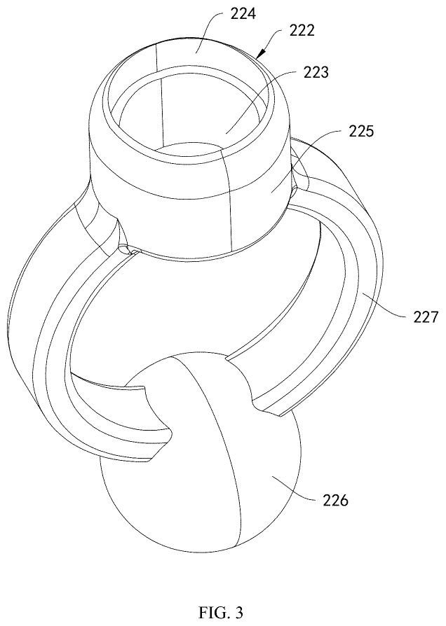

With reference to FIG. 2 and FIG. 3, it is understandable that, the swinging member 222 is provided with a first opening 223, and one end of the limiting assembly 300 is movably arranged in the first opening 223.

One end of the limiting assembly 300 is arranged in the first opening 223, and can abut against an inner wall of the first opening 223, so as to support the swinging member 222 and limit the swinging member 222.

Specifically, the first opening 223 is located below the through port 120, a length direction of the first opening 223 is set to be in the same direction as that of the through port 120, the first opening 223 may be arranged between the connecting member 221 and the magnet 210. During swinging of the swinging member 222, the limiting assembly 300 can abut against the inner side wall of the first opening 223, so that when the magnetic driving assembly 400 drives the magnet 210 to move in a first horizontal direction, the lamp body 230 is movable towards a second horizontal direction opposite to the first horizontal direction.

With reference to FIG. 1 to FIG. 3, it is understandable that, one side of the swinging member 222 close to the through port 120 is provided with a second opening 224, the connecting member 221 is arranged in the second opening 224, and the second opening 224 and the first opening 223 are communicated with each other.

By arranging the second opening 224, difficulty in connecting the connecting member 221 with the swinging member 222 can be reduced, and detachable connection between the connecting member 221 and the swinging member 222 can be achieved. The second opening 224 is communicated with the first opening 223, so that one end of the limiting assembly 300 can abut against one end of the connecting member 221 close to the limiting assembly 300. Specifically, a lower end of the connecting member 221 is provided with a groove, and an inner wall surface of the groove is a concave curved surface, which can reduce damage caused by collision between the limiting assembly 300 and the connecting member 221.

With reference to FIG. 2 and FIG. 3, it is understandable that, the swinging member 222 comprises a first connecting structure 225, a second connecting structure 226 and a connecting rod 227, the connecting rod 227 is arc-shaped, two connecting rods 227 are provided and arranged symmetrically, two ends of the connecting rod 227 are respectively connected with the first connecting structure 225 and the second connecting structure 226, the first connecting structure 225 is connected with the connecting member 221, and the magnet 210 is arranged on the second connecting structure 226.

The connecting rod 227 is arc-shaped, middle portions of the connecting rods 227 are concave in directions far away from each other, and two ends of the connecting rod 227 are connected with the first connecting structure 225 and the second connecting structure 226 respectively, so as to increase an area of a supporting surface of a center of gravity of the swinging member 222. The first connecting structure 225 is connected with the connecting member 221. Specifically, the first opening 223 and the second opening 224 are both arranged in the first connecting structure 225, and a weight of the second connecting structure 226 is greater than that of the first connecting structure 225, so that the center of gravity of the swinging member 222 can be further reduced, and then the center of gravity of the swinging member 222 is close to the magnet 210, thus reducing difficulty in driving the swinging member 222 to move by driving the magnet 210 to move by the magnetic driving assembly 400.

Specifically, the first connecting structure 225, the second connecting structure 226 and the connecting rod 227 are integrally formed to reduce difficulty in producing the swinging member 222. The first connecting structure 225 has a cross section larger than that of the through port 120, so that when the magnetic driving assembly 400 pushes the magnet 210 to move towards the through port 120, the first connecting structure 225 cannot move out of the accommodating cavity 110 from the through port 120, thus improving operating stability of the swinging assembly 220. The second opening 224 is arranged at one end of the first connecting structure 225 close to the second connecting structure 226, the limiting assembly 300 is partially located between the two connecting rods 227, and the connecting rod 227 is set to be arc-shaped to avoid collision between the limiting assembly 300 and the connecting rod 227, thus having an avoidance effect. The first opening 223 is arranged at one end of the first connecting structure 225 far away from the second connecting structure 226, and the magnet 210 is arranged at a position of the second connecting structure 226 far away from the first connecting structure 225, wherein one side of the second connecting structure 226 far away from the first connecting structure 225 is provided with a placing port, and the magnet 210 is placed in the placing port.

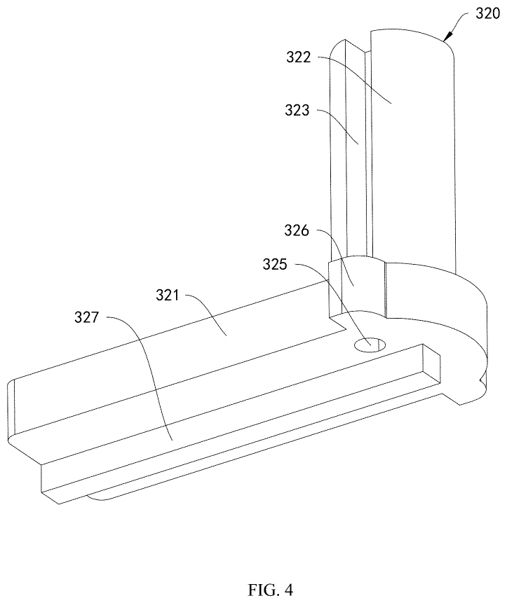

With reference to FIG. 2 and FIG. 4, it is understandable that, the limiting assembly 300 comprises a mounting member 310 and a limiting rod 320, the mounting member 310 is arranged on an inner wall of the accommodating cavity 110, the limiting rod 320 comprises a first rod member 321 and a second rod member 322, the first rod member 321 is connected with the mounting member 310, one end of the second rod member 322 is connected with the first rod member 321, and the other end of the second rod member 322 is movably arranged in the first opening 223.

The mounting member 310 is connected with the inner wall of the accommodating cavity 110 and connected with the limiting rod 320, and by arranging the mounting member 310, a position of the limiting rod in the accommodating cavity 110 can be fixed. Specifically, the mounting member 310 and the shell 100 are integrally formed. A mounting groove 311 is arranged in the mounting member 310, and the first rod member 321 of the limiting rod 320 is arranged in the mounting groove 311. The mounting member 310 is detachably connected with the limiting rod 320.

The limiting rod 320 is composed of the first rod member 321 and the second rod member 322, and the first rod member 321 and the second rod member 322 are integrally formed. The first rod member 321 is inserted into the mounting groove 311, one end of the first rod member 321 is located below the first opening 223, one end of the second rod member 322 is connected with the first rod member 321, and one end of the second rod member 322 extends into the first opening 223, and can abut against the first rod member 321, so that the swinging member 222 and the connecting member 221 can be supported. The second rod member 322 extends between the two connecting rods 227, so as to reduce difficulty in inserting the second rod member 322 into the first opening 223.

Specifically, the through port 120 is arranged at atop end of the shell 100, a length direction of the first opening 223 and a length direction of the through port 120 are both the vertical direction, the magnet 210 is arranged at a lower end of the swinging member 222, one end of the first rod member 321 extends between the two connecting rods 227, the second rod member 322 is located in a direction of the first connecting structure 225, and located between the two connecting rods 227, a length direction of the second rod member 322 is the vertical direction, and an upper end of the second rod member 322 extends into the first opening 223, and abuts against the connecting member 221. After the magnetic driving assembly stops working, the upper end of the second rod member 322 abuts against the connecting member 221, and the connecting member 221 is toppled over by manual swinging or a self-gravity of the swinging assembly 220 to abut against the inner wall of the through port 120, so as to avoid the connecting member 221 from moving out of the through port 120. During rotation of the swinging member 222, the connecting rod 227 of the swinging member 222 is rotatable to abut against the mounting member 310, and by arranging the mounting member 310, a rotation range of the swinging member 222 can be controlled. The two connecting rods 227 are arranged symmetrically, and the swinging member 222 is rotatable by 180°. Certainly, according to a different included angle between the connecting rods 227 around a vertical axis, the rotatable angle of the swinging member 222 may be other degrees.

With reference to FIG. 2 and FIG. 4, it is understandable that, the shell comprises a first shell body 101 and a second shell body 102, the first shell body 101 is detachably connected with the second shell body 102, the through port 120 and the accommodating cavity 110 are formed between the first shell body 101 and the second shell body 102, and the mounting member 310 is arranged on the first shell body 101.

The first shell body 101 and the second shell body 102 are arranged symmetrically, and the first shell body 101 and the second shell body 102 are detachably connected. The first shell body 101 and the second shell body 102 are arranged to be hollow, and the accommodating cavity 110 and the through port 120 can be formed after the first shell body 101 and the second shell body 102 are mounted, wherein the mounting member 310 is arranged on the first shell body 101. When the limiting rod 320 and the swinging member 222 are mounted, the first rod member of the limiting rod 320 can be inserted into the first opening 223 in the swinging member 222, then the second rod member 322 is inserted into the mounting member 310, and finally the second shell 102 is mounted, so as to reduce difficulty in mounting and detaching the swinging member 222.

Specifically, the first shell body 101 is provided with an inserting slot, the second shell body 102 is provided with an inserting block, and the inserting block is inserted into the inserting slot, so that the first shell body 101 and the second shell body 102 can be connected through a friction force between the inserting block and an inner wall of the inserting slot.

With reference to FIG. 2 to FIG. 4, it is understandable that, one end of the first rod member 321 close to the second rod member 322 is provided with a first through hole 325, the second rod member 322 is provided with a second through groove 324, and the first through hole 325 is communicated with the second through groove 324.

The first through hole 325 and the second through groove 324 are both used for accommodating a wire to facilitate wiring required by the lamp body 230 to emit light. By arranging the second through groove 324, the wire can be limited, so as to reduce possibility of winding of the wire with the swinging member 222.

Specifically, a plurality of first through holes 325 and a plurality of first through grooves 323 may be provided, and the first through holes 325 and the second through grooves 324 are communicated one by one to accommodate a plurality of wires. A length direction of the second through groove 324 is set in the same direction as that of the second rod member 322. Two second through groove 324 are provided and respectively arranged on two opposite sides of the second rod member 322, so as to reduce possibility of mutual winding of the wires located in the two second through grooves 324. Two first through holes 325 are provided correspondingly.

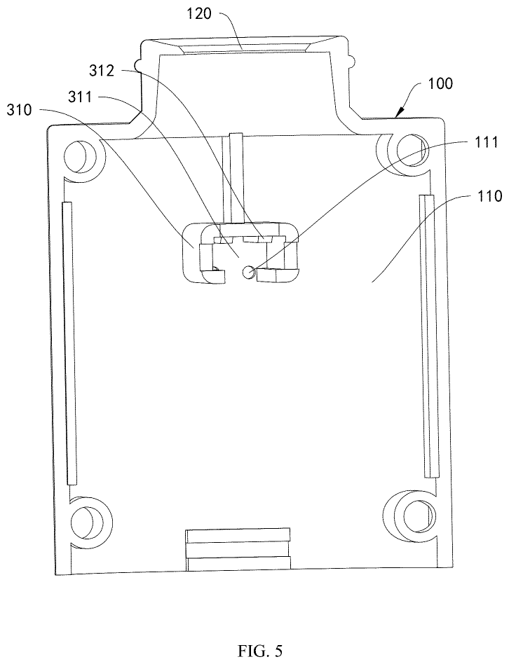

With reference to FIG. 2. FIG. 4 and FIG. 5, it is understandable that, the inner wall of the accommodating cavity 110 is provided with a second through hole 111, a first through groove 323 is defined between the first rod member 321 and the mounting member 310, and two ends of the first through groove 323 are respectively communicated with the first through hole 325 and the second through hole 111.

The second through hole 111 penetrates through the inner wall of the accommodating cavity 110, so that the wire outside the accommodating cavity 110 can extend into the accommodating cavity 110 from the second through hole 11. The first through groove 323 is defined between the first rod member 321 and the second through groove 324, and the external wire can extend into the first through groove 323. Because two ends of the first through groove 323 are respectively communicated with the first through hole 325 and the second through hole 111, the wire in the first through groove 323 can extend into the first through hole 325.

Specifically, the mounting groove 311 is arranged in the mounting member 310, a first bump 327 is arranged on the first rod member 321, and the first through groove 323 is defined between the first bump 327 and the mounting groove 311. A second bump 312 is arranged on an inner wall of the mounting groove 311, and the second bump 312 abuts against the first rod member 321, so that the first through groove 323 can be defined between the inner wall of the mounting groove 311 and the first rod member 321. One end of the first rod member 321 far away from the inner wall of the accommodating cavity 110 is provided with a limiting block 326, the limiting block 326 can abut against one end of the mounting member 310 far away from the inner wall of the accommodating cavity 110, so as to limit a depth of the first rod member 321 inserted into the mounting groove 311, so that there is a certain distance between the first rod member 321 and the inner wall of the accommodating cavity 110.

It is understandable that, the swinging part 200 further comprises a protecting member, and the protecting member is sleeved around the connecting member 221, and abuts against the swinging member 222.

By arranging the protecting member, the connecting member 221 can be protected, so that the connecting member 221 can abut against the inner wall of the through port 120 through the protecting member, so as to avoid the connecting member 221 and the swinging member 222 from abutting against the inner wall of the through port 120, thus reducing abrasion of the connecting member 221 and the swinging member 222.

Specifically, both the protecting member and the through port 120 have a circular cross section, and the cross section at a lower end of the protecting member is greater than that of the through port 120, so as to avoid the protecting member from moving out of the through port 120, and avoid the swinging assembly 220 from moving out of the through port 120, wherein the protecting member may be made of a material with a smooth surface, such as metal or other materials.

In the descriptions of the specification, the descriptions with reference to the terms “one embodiment”, “some embodiments” or “some examples”, etc., refer to that specific features, structures or characteristics described with reference to the embodiments or examples are included in at least one embodiment or example of the disclosure. In the specification, the schematic representation of the above terms does not necessarily mean the same embodiment or example. Moreover, the specific features, structures, materials or characteristics described may be combined in any one or more embodiments or examples in a suitable manner.

Although the embodiments of the disclosure have been shown and described, those of ordinary skills in the art may understand that various changes, modifications, substitutions and variations may be made to these embodiments without departing from the principle and purpose of the disclosure, and the scope of the disclosure is defined by the claims and their equivalents.

What is claimed is:

1. A candle lamp, comprising:
a shell provided with an accommodating cavity and a through port, wherein the through port is communicated with the accommodating cavity;
a swinging part comprising a magnet, a swinging assembly and a lamp body, wherein the swinging assembly is movably arranged in the accommodating cavity, one end of the swinging assembly is movably arranged at the through port and connected with the lamp body, the lamp body is located outside the accommodating cavity, and the magnet is connected with the swinging assembly; and
a magnetic driving assembly arranged in the accommodating cavity and located on one side of the magnet, wherein the magnetic driving assembly is capable of driving the magnet to move by a magnetic force.

2. The candle lamp according to claim 1, wherein the swinging assembly comprises a connecting member and a swinging member, the connecting member is connected with the swinging member and located at the through port, the lamp body is connected with the connecting member, the magnet is arranged on one side of the swinging member far away from the connecting member, and the magnetic driving assembly is located on one side of the magnet far away from the connecting member.

3. The candle lamp according to claim 2, further comprising a limiting assembly, wherein the limiting assembly is arranged in the accommodating cavity, and the limiting assembly is located on one side of the through port and is capable of abutting against the swinging assembly.

4. The candle lamp according to claim 3, wherein the swinging member is provided with a first opening, and one end of the limiting assembly is movably arranged in the first opening.

5. The candle lamp according to claim 2, wherein the swinging member comprises a first connecting structure, a second connecting structure and a connecting rod, the connecting rod is arc-shaped, two connecting rods are provided and arranged symmetrically, two ends of the connecting rod are respectively connected with the first connecting structure and the second connecting structure, the first connecting structure is connected with the connecting member, and the magnet is arranged on the second connecting structure.

6. The candle lamp according to claim 4, wherein the limiting assembly comprises a mounting member and a limiting rod, the mounting member is arranged on an inner wall of the accommodating cavity, the limiting rod comprises a first rod member and a second rod member, the first rod member is connected with the mounting member, one end of the second rod member is connected with the first rod member, and the other end of the second rod member is movably arranged in the first opening.

7. The candle lamp according to claim 6, wherein the shell comprises a first shell body and a second shell body, the first shell body is detachably connected with the second shell body, the through port and the accommodating cavity are formed between the first shell body and the second shell body, and the mounting member is arranged on the first shell body.

8. The candle lamp according to claim 6, wherein one end of the first rod member close to the second rod member is provided with a first through hole, the second rod member is provided with a second through groove, and the first through hole is communicated with the second through groove.

9. The candle lamp according to claim 6, wherein the inner wall of the accommodating cavity is provided with a second through hole, a first through groove is defined between the first rod member and the mounting member, and two ends of the first through groove are respectively communicated with the first through hole and the second through hole.

10. The candle lamp according to claim 4, wherein one side of the swinging member close to the through port is provided with a second opening, the connecting member is arranged in the second opening, and the second opening and the first opening are communicated with each other.
